(19) United States
(12) Patent Application Publication
(10) Pub. No.: US 2020/0198625 A1
(43) Pub. Date: Jun. 25, 2020

(54) VEHICLE AND METHOD FOR CONTROLLING DECELERATION THEREFOR

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIA-YONG ZHOU, Shenzhen (CN)

(21) Appl. No.: 16/556,614

(22) Filed: Aug. 30, 2019

(30) Foreign Application Priority Data
Dec. 25, 2018 (CN) 201811594200.9

(51) Int. Cl. B60W 30/09; B60W 30/095; G08G 1/16; B60W 30/085

(52) U.S. Cl. CPC B60W 30/09; B60W 30/0956; B60W 2050/008; G08G 1/166; B60W 30/085; G08G 1/162

(57) ABSTRACT

A method for controlling deceleration applicable in one vehicle which is following another includes detecting whether there is a vehicle which is in front and whether the distance between the vehicles is within a predetermined distance range at predetermined time intervals. When determining that such a vehicle is in front, a first communication device on the trailing vehicle communicates with the front vehicle. Data as to the speed of the leading vehicle is acquired through the first communication device. If the front vehicle decelerates according to the acquired speed data, the trailing vehicle is itself controlled to decelerate to avoid any rear-end collision.

### CROSS-REFERENCE TO RELATED APPLICATIONS

This application claims priority to Chinese Patent Application No. 201811594200.9 filed on Dec. 25, 2018, the contents of which are incorporated by reference herein.

### FIELD

The subject matter herein generally relates to vehicle control technology, and particularly to a vehicle and a method for controlling deceleration therefor.

### BACKGROUND

A driver may fail to brake in time because of inattention, resulting a rear-end accident. Furthermore, even though the driver is careful, the rear-end accident is still possible when drivers of other nearby vehicles are being inattentive, thus threatening the drivers' safety.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a vehicle.

FIG. 2 is a schematic diagram of an embodiment of a driving scenario of the vehicle and a front vehicle.

FIG. 3 illustrates a flowchart of an embodiment of a method for controlling deceleration.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

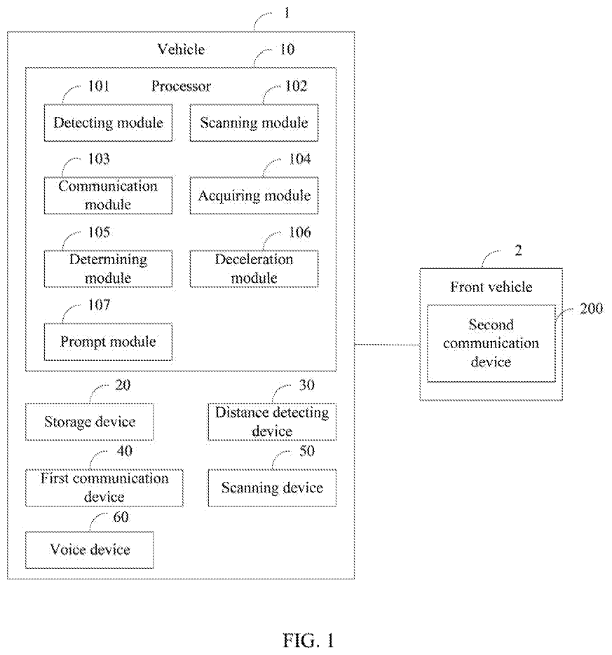

FIG. 1 illustrates an embodiment of a vehicle 1. The vehicle 1 can automatically decelerate when a front vehicle (hereinafter front vehicle 2) decelerates, thus avoiding a rear-end accident.

In at least one embodiment, the vehicle 1 includes, but is not limited to, a processor 10, a storage device 20, a distance detecting device 30, a first communication device 40, a scanning device 50, and a voice device 60. FIG. 1 illustrates only one example of the vehicle 1, other examples can include more or fewer components than illustrated, or have a different configuration of the various components in other embodiments.

The processor 10 can be a central processing unit (CPU), a microprocessor, or other data processor chip that performs functions of the vehicle 1.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium.

In at least one embodiment, the distance detecting device 30 can be an infrared sensor. The distance detecting device 30 can detect distances according to infrared rays which are reflected. In other embodiments, the distance detecting device 30 can also be an electromagnetic radiation sensor, the distance detecting device 30 can detect the distances according to electromagnetic waves.

In at least one embodiment, the vehicle 1 includes two first communication devices 40. The two first communication devices 40 are respectively arranged on a front registration plate and a rear registration of the vehicle 1. The two first communication devices 40 can be a communication chip with a predetermined identification number, and the communication chip supports dial-up communication. The predetermined identification number can be a number of the registration plate.

In at least one embodiment, the scanning device 50 is arranged on a front registration plate of the vehicle 1. The scanning device 50 can be a camera. The scanning device 50 captures at least one image of a rear registration plate of the front vehicle 2. In other embodiments, the scanning device 50 can also be a laser scanner.

In at least one embodiment, the voice device 60 is arranged in the vehicle 1. The voice device 60 can be a voice box. The voice device 60 can output voice messages.

In at least one embodiment, the front vehicle 2 at least includes a second communication device 200. The second communication device 200 can also be a communication chip with a predetermined identification number.

As illustrated in FIG. 1, the vehicle 1 at least includes a detecting module 101, a scanning module 102, a communication module 103, an acquiring module 104, a determining module 105, a deceleration module 106, and a prompt module 107. The modules 101-107 can be collections of software instructions stored in the storage device 20 of the vehicle 1 and executed by the processor 10. The modules 101-107 also can include functionality represented as hardware or integrated circuits, or as software and hardware combinations, such as a special-purpose processor or a general-purpose processor with special-purpose firmware.

The detecting module 101 is used to control the distance detecting device 30 to detect whether a front vehicle 2 is within a predetermined distance range in front of the vehicle 1, at predetermined time intervals.

In at least one embodiment, the detecting module 101 controls the distance detecting device 30 to detect the presence of the front vehicle 2 in front of the vehicle 1, at the predetermined time intervals. In at least one embodiment, the predetermined time interval can be two seconds.

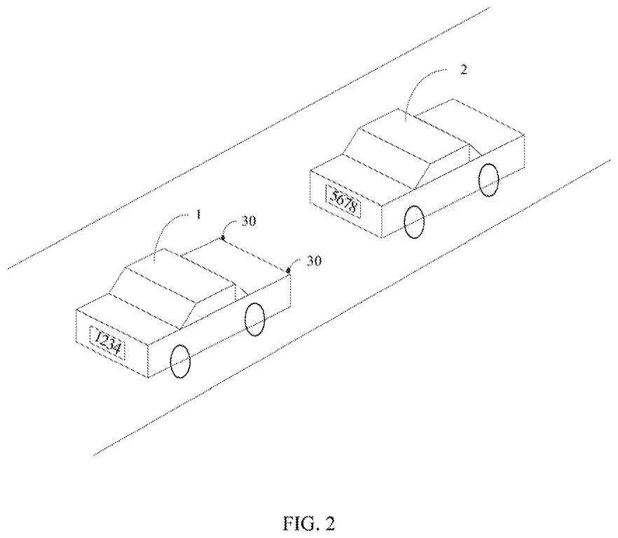

Referring to FIG. 2, the distance detecting device 30 is arranged on each of two ends of a headstock of the vehicle 1. The two distance detecting devices 30 transmit infrared rays forward. When one or both of the two distance detecting devices 30 receive reflected infrared rays, the detecting module 101 determines that there is the front vehicle 2 in front of the vehicle 1. When neither of the two distance detecting devices 30 receives the reflected infrared rays, the detecting module 101 determines that there is no front vehicle 2 in front of the vehicle 1.

When the front vehicle 2 is in front of the vehicle 1, the detecting module 101 further determines whether a distance between the vehicle 1 and the front vehicle 2 is equal to or less than a predetermined distance.

In detail, the distance detecting device 30 can calculate the distance between the vehicle 1 and the front vehicle 2 according to a time interval between transmitting the infrared rays and receiving the reflected infrared rays, and a propagation speed of the infrared rays.

The detecting module 101 determines whether the calculated distance is equal to or less than the predetermined distance. When the calculated distance is equal to or less than the predetermined distance, the detecting module 101 determines that the front vehicle 2 is within the predetermined distance range of the vehicle 1. In at least one embodiment, the predetermined distance can be thirty meters, the predetermined distance range can be a range which is equal to or less than thirty meters.

When the detecting module 101 determines that the front vehicle 2 is within the predetermined distance range in front of the vehicle 1, the scanning module 102 is used to control the scanning device 50 to scan a registration number on the registration plate of the front vehicle 2.

In at least one embodiment, when the detecting module 101 determines that the front vehicle 2 is within the predetermined distance range in front of the vehicle 1, the scanning module 102 controls the scanning device 50 to capture an image of a rear registration plate of the front vehicle 2, and acquires the number of the registration plate by recognizing the captured image.

When the detecting module 101 determines that the front vehicle 2 is within the predetermined distance range in front of the vehicle 1, the communication module 103 controls the first communication device 40 to communicate with the front vehicle 2.

In at least one embodiment, when the detecting module 101 determines that the front vehicle 2 is within the predetermined distance range in front of the vehicle 1, the communication module 103 controls the first communication device 40 to communicate with the second communication device 200 of the front vehicle 2 by dialing-up.

In detail, the communication module 103 acquires the registration number of the front vehicle 2 which is scanned by the scanning device 50 from the scanning module 102, and then controls the first communication device 40 to transmit a dial-up request to the second communication device 200 using the registration number. When the second communication device 200 receives the dial-up request, the second communication device 200 can determine whether the dialed number is the same as the registration number of the front vehicle 2. When the second communication device 200 determines that the dialed number is the same as the registration number of the front vehicle 2, the second communication device 200 communicates with the first communication device 40 in response to the dial-up request.

The acquiring module 104 is used to acquire speed data of the front vehicle 2 through the first communication device 40.

In at least one embodiment, the second communication device 200 connects with a center console of the front vehicle 2, and acquires speed of the front vehicle 2 from the center console in real time. When the second communication device 200 communicates with the first communication device 40, the second communication device 200 can automatically transmit the speed data to the first communication device 40. Thus the acquiring module 104 controls the first communication device 40 to acquire the speed data of the front vehicle 2 from the second communication device 200.

The determining module 105 is used to determine whether the front vehicle 2 is decelerating according to the acquired speed data.

In at least one embodiment, the determining module 105 compares a number of speed values in the acquired speed data. When a speed value is less than a former speed value, the determining module 105 determines that the another vehicle 2 is decelerating.

In other embodiments, when a predetermined number of speed values decreases progressively, the determining module 105 determines that the front vehicle 2 is decelerating. The predetermined number can be five.

When the determining module 105 determines that the front vehicle 2 is decelerating, the deceleration module 106 is used to control the vehicle 1 to decelerate.

In at least one embodiment, the deceleration module 106 controls the vehicle 1 to synchronously decelerate according to the speed data of the front vehicle 2, thus keeping a certain distance between the vehicles.

In at least one embodiment, the deceleration module 106 controls the vehicle 1 to decelerate by reducing power of an engine of the vehicle 1.

In other embodiments, the deceleration module 106 can also control the vehicle 1 to decelerate by a braking system of the vehicle 1.

When the determining module 105 determines that the front vehicle 2 decelerates, the prompt module 107 is used to control the voice device 60 to output a voice message to prompt the driver of the vehicle 1 to slow down.

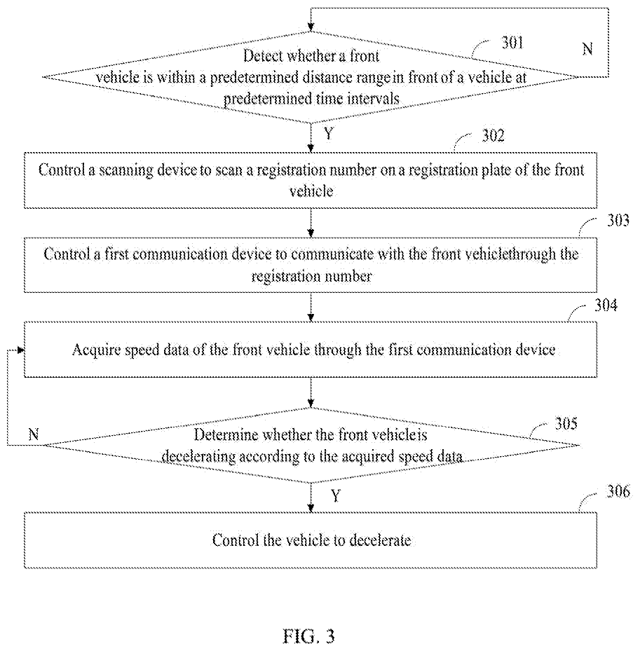

FIG. 3 illustrates a flowchart of an embodiment of a method for controlling deceleration. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed.

Additional blocks may be added or fewer blocks may be utilized, without departing from this disclosure. The example method can begin at block 301.

At block 301, the detecting module 101 controls the distance detecting device 30 to detect whether the front vehicle 2 is within a predetermined distance range in front of the vehicle 1, at predetermined time intervals. When there is such front vehicle 2, the process goes to block 302. When there is no front vehicle in the predetermined distance range in front of the vehicle 1, the process continues in block 301.

At block 302, the scanning module 102 controls the scanning device 50 to scan a registration number of the registration plate of the front vehicle 2.

At block 303, the communication module 103 controls the first communication device 40 to communicate with the front vehicle 2 through the scanned registration number.

At block 304, the acquiring module 104 acquires speed data of the front vehicle 2 through the first communication device 40.

At block 305, the determining module 105 determines whether the front vehicle 2 is decelerating according to the acquired speed data. When the front vehicle 2 decelerates, the process goes to block 306. When the front vehicle 2 does not decelerate, the process remains in block 304.

At block 306, the deceleration module 106 controls the vehicle 1 to decelerate.

In at least one embodiment, the method can further include controlling the voice device 60 to output a voice message to prompt the driver of the vehicle 1 to slow down when the front vehicle 2 decelerates.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A vehicle comprising:
at least one processor;
a distance detecting device coupled to the at least one processor;
a first communication device coupled to the at least one processor; and
a storage device coupled to the at least one processor and storing instructions for execution by the at least one processor to cause the at least one processor to:
control the distance detecting device to detect whether a front vehicle is within a predetermined distance range in front of the vehicle at predetermined time intervals;
control, when the front vehicle is within the predetermined distance range in front of the vehicle, the first communication device to communicate with the front vehicle;
acquire speed data of the front vehicle through the first communication device;
determine whether the front vehicle is decelerating according to the acquired speed data; and
control, when the front vehicle is decelerating, the vehicle to decelerate.

2. The vehicle according to claim 1, wherein the at least one processor is further caused to:
control the distance detecting device to detect whether the front vehicle is in front of the vehicle at the predetermined time intervals;
determine, when the front vehicle is in front of the vehicle at the predetermined time intervals, whether a distance between the vehicle and the front vehicle is equal to or less than a predetermined distance; and
determine, when the distance is equal to or less than the predetermined distance, that the front vehicle is within the predetermined distance range in front of the vehicle.

3. The vehicle according to claim 1, wherein if the front vehicle is attached with a second communication device, the first communication device is adapted to communicate with the second communication device, each of the first and the second communication device is a communication chip with predetermined identification numbers.

4. The vehicle according to claim 3, wherein at the least one processor is further caused to:
control, when the front vehicle is within the predetermined distance range in front of the vehicle, the first communication device to communicate with the second communication device of the front vehicle by dialing-up.

5. The vehicle according to claim 4, further comprising:
a scanning device arranged on a front registration plate of the vehicle; and
two first communication devices, wherein the two first communication devices are respectively arranged on the front registration plate and a rear registration plate of the vehicle.

6. The vehicle according to claim 5, wherein at the least one processor is further caused to:
control, when the front vehicle is within the predetermined distance range in front of the vehicle, the scanning device to scan a registration number on the registration plate of the front vehicle; and
control the first communication device to communicate with the second communication device of the front vehicle by dialing the scanned registration number.

7. The vehicle according to claim 6, wherein the at least one processor is further caused to:
control the first communication device to acquire speed data of the front vehicle from the second communication device; and
determine whether the front vehicle is decelerating according to the acquired speed data of the front vehicle.

8. A method for controlling deceleration applicable in a vehicle comprising:
controlling a distance detecting device of the vehicle to detect whether a front vehicle is within a predetermined distance range in front of the vehicle at predetermined time intervals;
controlling, when the front vehicle is within the predetermined distance range in front of the vehicle, a first communication device to communicate with the front vehicle;
acquiring speed data of the front vehicle through the first communication device;
determining whether the front vehicle is decelerating according to the acquired speed data; and
controlling, when the front vehicle is decelerating, the vehicle to decelerate.

9. The method according to claim 8, wherein the method of controlling the distance detecting device of the vehicle comprises:
controlling the distance detecting device to detect whether the front vehicle is in front of the vehicle at the predetermined time intervals;
determining, when the front vehicle is in front of the vehicle, whether a distance between the vehicle and the front vehicle is equal to or less than a predetermined distance; and
determining, when the distance is equal to or less than the predetermined distance, that the front vehicle is within the predetermined distance range in front of the vehicle.

10. The method according to claim 8, wherein if the front vehicle is attached with a second communication device, the first communication device is adapted to communicate with the second communication device, each of the first and the second communication device is a communication chip with predetermined identification numbers.

11. The method according to claim 10, wherein the method of controlling a first communication device to communicate with the front vehicle comprises:
controlling, when the front vehicle is within the predetermined distance range in front of the vehicle, the first communication device to communicate with the second communication device of the front vehicle by dialing-up.

12. The method according to claim 11, further comprising:
attaching a scanning device and two first communication devices to the vehicle, wherein the scanning device is arranged on a front registration plate of the vehicle, the two first communication devices are respectively arranged on the front registration plate and a rear registration plate of the vehicle.

13. The method according to claim 12, further comprising:
controlling, when the front vehicle is within the predetermined distance range in front of the vehicle, the scanning device to scan a registration number on the registration plate of the front vehicle; and
controlling the first communication device to communicate with the second communication device of the front vehicle by dialing the scanned registration number.

14. The method according to claim 13, wherein the method of acquiring speed data of the front vehicle through the first communication device comprises:
controlling the first communication device to acquire speed data of the front vehicle from the second communication device; and
determining whether the front vehicle is decelerating according to the acquired speed data of the front vehicle.
